(19) United States
(12) Patent Application Publication
(10) Pub. No.: US 2026/0029914 A1
(43) Pub. Date: Jan. 29, 2026

(54) DATA STORAGE AND DECOMPRESSION IN A MEMORY SYSTEM

(71) Applicant: Micron Technology, Inc., Boise, ID (US)

(72) Inventor: Marco Redaelli, München (DE)

(21) Appl. No.: 19/273,044

(22) Filed: Jul. 17, 2025

Related U.S. Application Data
(60) Provisional application No. 63/676,746, filed on Jul. 29, 2024.

(51) Int. Cl. G06F 3/06

(52) U.S. Cl. CPC G06F 3/0608; G06F 3/0655; G06F 3/0679

(57) ABSTRACT

Methods, systems, and devices for data storage and decompression in a memory system are described. The described techniques provide for a memory system to store compressed data during a manufacturing stage according to a first write configuration and store decompressed data according to a second write configuration. The first write configuration may be associated with writing to a set of single-level cells (SLCs) as part of a pre-programming operation and the second write configuration may be associated with writing to a set of multiple-level cells when the memory system enters an operational mode. In some cases, the compressed data may include a bitmap indicating a relationship between one or more symbols each representing a sequence of bits and a respective set of one or more locations within the data.

### CROSS REFERENCE

The present Application for patent claims priority to U.S. Patent Application No. 63/676,746 by Redaelli, entitled “DATA STORAGE AND DECOMPRESSION IN A MEMORY SYSTEM,” filed Jul. 29, 2024, which is assigned to the assignee hereof, and which is expressly incorporated by reference in its entirety herein.

### TECHNICAL FIELD

The following relates to one or more systems for memory, including data storage and decompression in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports data storage and decompression in a memory system in accordance with examples as disclosed herein.

FIG. 2 shows an example of a process that supports data storage and decompression in a memory system in accordance with examples as disclosed herein.

FIG. 3 shows a block diagram of a memory system that supports data storage and decompression in accordance with examples as disclosed herein.

FIG. 4 shows a flowchart illustrating a method or methods that support data storage and decompression in a memory system in accordance with examples as disclosed herein.

### DETAILED DESCRIPTION

Memory systems may support various configurations for operating in different deployment scenarios, which may be supported by one or more firmware images (e.g., instruction images, code images, instruction sets, programs). For example, a firmware image may be loaded to a memory system to define one or more operations executable by the memory system, or to configure the memory system to perform a set of instructions, among other configurations. In some examples, a firmware image may be loaded onto a memory system during a manufacturing operation (e.g., a manufacturing stage) of the memory system, which may be performed prior to the memory system being in an operational mode (e.g., before being coupled with a customer system). The memory system may be expected to maintain data (e.g., the firmware image) that is programmed during manufacturing for some duration, such as until the memory system enters the operational mode (e.g., until the memory system is powered on, until the memory system is coupled with a host system). For example, in the context of a memory system included in an automotive system on chip (SoC) implementation, the memory system may be expected to maintain data for a duration between manufacture of a vehicle, or a processing system thereof (e.g., the SoC), and a first usage of the vehicle, which may include a relatively long ‘on the shelf’ duration for which the vehicle is inactive (e.g., idle, powered off).

A memory system may utilize single-level cells (SLCs) for storing and maintaining data for an inactive duration, for example, due to SLCs being relatively robust (e.g., in comparison to multiple-level cells such as tri-level cells (TLCs), including in view of thermal effects such as soldering or storage temperatures, and relatively larger read margins for SLCs). However, a capacity of the memory system allocated for SLCs (e.g., a size of an SLC array, a size of an array with memory cells configured in an SLC configuration) may be relatively small in comparison to a size of a firmware image, which may limit a size of a firmware image that can be stored in SLCs. Additionally, or alternatively, transferring or programming the firmware image into the memory system may be relatively time-consuming, particularly during a manufacturing stage, during which the data transfer or programming may reduce or otherwise limit manufacturing efficiency.

In accordance with examples as described herein, a memory system may be configured to receive compressed data (e.g., associated with a firmware image, associated with a relatively small data size) during a manufacturing stage, to be written to the memory system according to a first write configuration. The memory system may be further configured to decompress the compressed data and store the decompressed data (e.g., associated with a relatively larger data size) according to a second write configuration. For example, the first write configuration may be associated with writing the compressed data to a set of SLCs as part of a pre-programming operation (e.g., during a manufacturing stage) and the second write configuration may be associated with writing the decompressed data to a set of multiple-level cells, such as multi-level cells (MLCs), TLCs, quad-level cells (QLCs), or other higher-density storage techniques. In some cases, the compressed data may include a bitmap indicating a relationship between one or more symbols (e.g., each representing a sequence of bits) and a respective set of one or more locations within the data (e.g., a firmware image file). In some implementations, the memory system may decompress and transfer the data in response to an indication to decompress the data, which may be received from a host system or be based on the memory system entering an operational mode. For example, a host system may transmit an indication to the memory system in response to a first power on of a system (e.g., a system including the memory system) after manufacturing of the system is complete. Such techniques may improve pre-programming operations for loading data to a memory system during manufacturing, and support storage of such data in a relatively robust (e.g., high-endurance) manner.

In addition to applicability in memory systems as described herein, techniques for data storage and decompression may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve sustainability of various systems by improving manufacturing efficiency (e.g., by reducing an amount of data to be transferred during manufacturing operations), memory system robustness (e.g., for supporting relatively robust data retention during or between manufacturing operations), and memory system performance (e.g., by increasing available storage during system operation by storing decompressed data in accordance with a relatively higher-density storage configuration), among other benefits.

Features of the disclosure are illustrated and described in the context of systems, devices, and circuits. Features of the disclosure are further illustrated and described in the context of a process, a block diagram, and a flowchart.

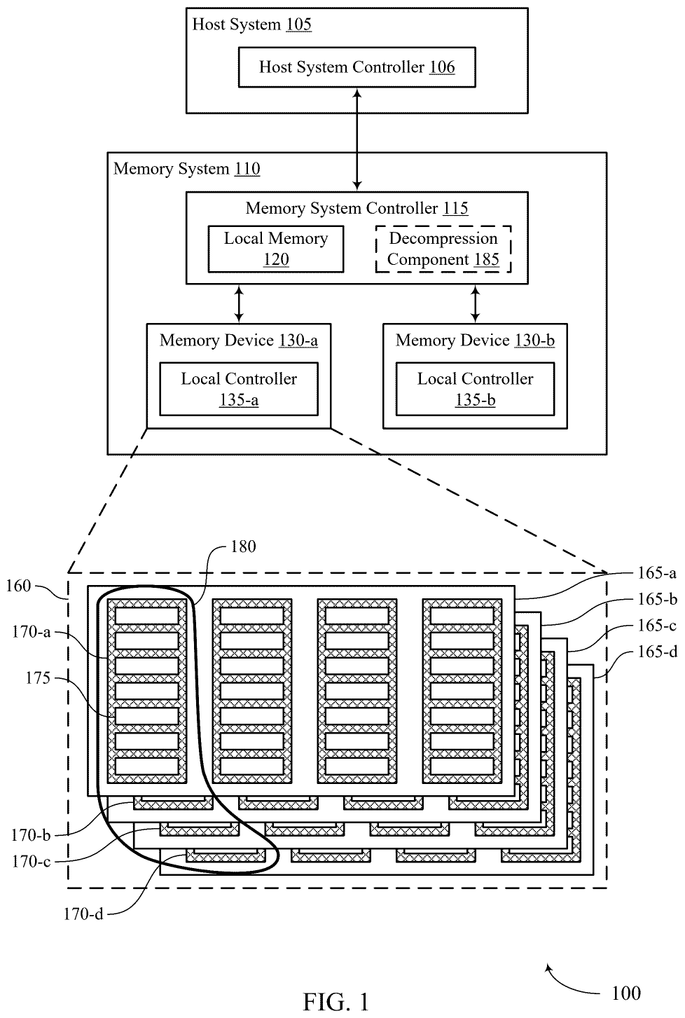

FIG. 1 shows an example of a system 100 that supports data storage and decompression in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, a firmware image may be loaded to a memory system 110 to define one or more operations executable by the memory system 110 (e.g., by a memory system controller 115, by one or more local controllers 135), or to configure the memory system 110 to perform a set of instructions, among other configurations. In some examples, a firmware image may be loaded onto a memory system 110 during a manufacturing operation (e.g., a manufacturing stage) of the memory system 110, which may be performed prior to the memory system 110 being in an operational mode (e.g., before being coupled in a system 110, before being coupled with a customer host system 105). The memory system 110 may be expected to maintain data (e.g., the firmware image) that is programmed during manufacturing for some duration, such as until the memory system 110 enters the operational mode (e.g., until the memory system 110 is powered on, until the memory system is coupled with a host system 105). For example, in the context of a memory system 110 included in an automotive system on chip (SoC) implementation, the memory system 110 may be expected to maintain data for a duration between manufacture of a vehicle, or a processing system thereof (e.g., the SoC), and a first usage of the vehicle, which may include a relatively long ‘on the shelf’ duration for which the vehicle is inactive (e.g., idle, powered off).

A memory system 110 (e.g., a memory system controller 115) may utilize a set of SLCs (e.g., of one or more memory devices 130, of local memory 120) for storing and maintaining data for an inactive duration, for example, due to SLCs being relatively robust (e.g., in comparison to multiple-level cells such as TLCs, including in view of thermal effects such as soldering or storage temperatures, and relatively larger read margins for SLCs). However, a capacity of the memory system 110 allocated for SLCs (e.g., a size of an SLC array, a size of an array with memory cells configured in an SLC configuration) may be relatively small in comparison to a size of a firmware image, which may limit a size of a firmware image that can be stored in SLCs. Additionally, or alternatively, transferring or programming the firmware image into the memory system 110 may be relatively time-consuming, particularly during a manufacturing stage, during which the data transfer or programming may reduce or otherwise limit manufacturing efficiency.

In accordance with examples as described herein, a memory system 110 (e.g., a memory system controller 115) may be configured to receive compressed data (e.g., from a host system 105, associated with a firmware image, associated with a relatively small data size) during a manufacturing stage, to be written to the memory system 110 according to a first write configuration. The memory system 110 may be further configured to decompress the compressed data and store the decompressed data (e.g., associated with a relatively larger data size) according to a second write configuration. For example, the first write configuration may be associated with writing the compressed data to a set of SLCs as part of a pre-programming operation (e.g., during a manufacturing stage), such as writing to SLCs included in one or more memory devices 130 or local memory 120. The second write configuration may be associated with writing the decompressed data to a set of multiple-level cells (e.g., MLCs, TLCs, QLCs, or other higher-density storage techniques), such as a set of multiple-level cells included in one or more memory devices 130 or local memory 120. In some cases, the compressed data may include a bitmap indicating a relationship between one or more symbols (e.g., each representing a sequence of bits) and a respective set of one or more locations within the data (e.g., a firmware image file).

In some implementations, a memory system controller 115 may decompress the compressed data (e.g., using a decompression component 185, which may be included in or operated in accordance with the memory system controller 115), and the memory system controller 115 may transfer the decompressed data to the set of multiple-level memory cells in response to an indication to decompress the data, which may be received from a host system 105 or be based on the memory system 110 entering an operational mode. For example, a host system 105 may transmit a command to the memory system 110 in response to a first power on of a system 100 (e.g., a system 100 including the memory system 110) after manufacturing of the system 100 is complete. Such techniques may improve various aspects of a memory system 110, or a system 100 that includes the memory system, by improving manufacturing efficiency (e.g., by reducing an amount of data to be transferred during manufacturing operations), memory system robustness (e.g., for supporting relatively robust data retention during or between manufacturing operations), and memory system performance (e.g., by increasing available storage during system operation by storing decompressed data in accordance with a relatively higher-density storage configuration), among other benefits.

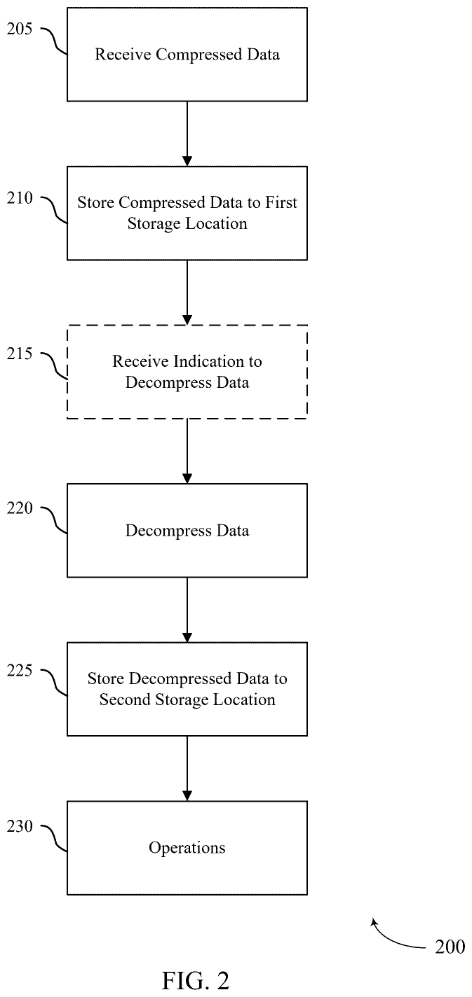

FIG. 2 shows an example of a process 200 that supports data storage and decompression in a memory system in accordance with examples as disclosed herein. The process 200 may implement, or be implemented by, one or more aspects of the system 100. For example, the process 200 may show an example of operations performed by a memory system 110 (e.g., a UFS device, an automotive UFS device, by a memory system controller 115, one or more local controllers 135, or a combination thereof) in accordance with information received from one or more host systems 105. The process 200 may support a memory system 110 loading and storing compressed data (e.g., a firmware image) during a manufacturing stage of at least a portion of the memory system 110, and later decompressing the data to support the memory system 110 entering an operational mode. In some cases, such operations may include the memory system 110 communicating with one or more host systems 105 at different stages of manufacturing and operation. Alternative examples of the following may be implemented, in which some processes are performed in a different order than described or are not performed. In some cases, operations may include additional features not mentioned below, or further operations may be added.

At 205, the memory system 110 (e.g., a memory system controller 115) may receive compressed data. In some examples, the compressed data may correspond to a firmware image, which may define a set of operations (e.g., default operations, core operations, memory system operations), or configure the memory system 110 to perform a set of instructions, among other configurations. In some cases, a memory system controller 115 may receive the compressed data from a host system 105 (e.g., a first host system, a manufacturing host system) as part of a pre-programming operation (e.g., as part of a production state awareness (PSA) flow). For example, the first host system 105 may compress the data (e.g., external to the memory system 110, using a SoC of the first host system 105 or data I/O equipment), or the first host system 105 may have received the data as compressed by another system, and the first host system 105 may load the compressed data to one or more memory systems 110 during the manufacturing of the one or more memory systems 110 (e.g., leveraging a one-time compression for repeated application across multiple devices).

A compression algorithm for the data may be selected to balance compression ratio, decompression speed, and complexity. In automotive applications, for example, reliability may be of relatively high importance, such that lossless compression methods may be implemented to support relatively high data integrity and accuracy. Selection of a compression algorithm may involve various evaluations of the specific characteristics and constraints of a given application.

In an illustrative example of compression techniques that may be implemented (e.g., in the context of pre-programming with compressed images), image data may be divided into symbols (e.g., code blocks, data segments) and a bitmap for mapping symbols to locations of the data (e.g., locations in the decompressed data). For example, symbols may represent distinct components or elements within the image data, such that each symbol is associated with a respective sequence (e.g., pattern) of bits. By analyzing and categorizing data (e.g., a firmware image) into meaningful symbols, a compression algorithm can identify recurring patterns or structures that can be efficiently compressed and programmed. For example, frequently occurring code sequences or data patterns can be grouped into symbols, supporting more effective compression and storage optimization. A bitmap can serve as a representation of the data (e.g., the entire firmware image, a representation of the decompressed data), providing a comprehensive overview of the data distribution and layout. By combining symbols with the bitmap, a compression algorithm can achieve a balance between efficient compression and streamlined programming. Such a bitmap may outline the structure of the data, which may facilitate sequential programming of symbols (e.g., within a PSA flow).

Thus, in accordance with these and other techniques, compressed data received at 205 may include one or more symbols and a bitmap indicating a relationship between each symbol and a respective set of one or more locations (e.g., information regarding where each symbol occurs, within a firmware image file). For example, a compression algorithm (e.g., of a host system 105, or another processing system) may have identified recurring patterns or structures in data to be provided to one or more memory systems 110, which may be categorized into symbols and communicated in a compressed manner to the memory system(s) 110. Such an approach may enable a manufacturer to configure a programming process by prioritizing pre-programming of symbols based on their significance and frequency within the data. Thus, a memory system 110 receiving the compressed data during the pre-programming operation may improve performance of the pre-programming operation in comparison to receiving decompressed data (e.g., the compressed data may be associated with a relatively lower data size, such as being represented by fewer bits, or a data transfer may be performed in accordance with reduced bandwidth or throughput, or both).

At 210, the memory system 110 (e.g., a memory system controller 115, one or more local controllers 135, or a combination thereof) may store the compressed data to a first storage location of the memory system 110. The memory system 110 may store the compressed data in accordance with a first write configuration, which may be associated with writing the data to memory cells having a first storage density (e.g., using single-level cells (SLCs), using memory cells each configured to store a single bit of data). For example, the memory system 110 may store, in accordance with the first write configuration, the compressed data to a set of SLCs (e.g., corresponding to the first storage location), such as one or more SLC arrays included in one or more memory devices 130 of the memory system 110, or in local memory 120 of a memory system controller 115, or any combination thereof. In some implementations, transfer of one symbol to a memory system 110 (e.g., associated with the operations of 205) can occur concurrently with a previous symbol being programmed by the memory system 110 (e.g., associated with the operations of 210), with the two operations (e.g., the operations of 205 and 210) being performed concurrently (e.g., in parallel). Such a concurrent processing capability may further streamline a programming sequence, reducing overall programming time and enhancing throughput.

In some examples, storing compressed data to a set of SLCs may leverage relatively faster programming speeds than higher-density storage techniques (e.g., faster programming speeds than writing other multiple-level cell techniques), thereby reducing latency associated with programming during manufacturing and improving manufacturing efficiency. Additionally, or alternatively, storing compressed data to a set of SLCs may leverage a relatively higher robustness associated with maintaining information in SLCs (e.g., relatively higher data retention characteristics, relatively wider read margins), thereby reducing the likelihood of data corruption associated with idle durations of the memory system 110, such as a duration between manufacturing and operation of the memory system 110 (e.g., an ‘on the shelf’ duration). In some examples, a capacity of SLCs may be relatively small in comparison to a size of the decompressed data, and compressing the data may support the memory system 110 storing the data to the set of SLCs, rather than other higher-density write configurations (e.g., allowing for additional information to be stored to improve performance and functionality of the memory system 110).

At 215, in some examples, the memory system 110 (e.g., the memory system controller 115) may receive an indication to decompress the compressed data. In some cases, the memory system 110 may receive the indication to decompress the compressed data from a second host system 105 (e.g., different than a host system 105 from which compressed data is received at 205), which may be received after the memory system 110 is coupled (e.g., soldered, reflowed, in electronic communication) with the second host system 105. For example, the memory system 110 may receive compressed data at 205 from a first host system 105 (e.g., a manufacturing system, a pre-programming system, a memory system integration system) prior to coupling with the second host system 105. The second host system 105 may be part of a system (e.g., a customer system, a system 100, a vehicle, or processing system thereof) in which the memory system 110 is deployed for operation. For example, the second host system 105 may be associated with a vehicle, and the memory system 110 may be coupled with the second host system 105 as part of the manufacture of the vehicle (e.g., if the memory system 110 is implemented in an automotive SoC). In some examples, the memory system 110 (e.g., the memory system controller 115) may receive the indication to decompress the compressed data in response to the memory system 110 entering an operational mode (e.g., a first power-on of the device including the memory system 110). In some other examples, the memory system 110 may receive the indication to decompress the compressed data in response to another initialization trigger, such as a decompression being triggered during manufacturing, before the first power-on, or a duration after the first power-on, among other examples. In some examples, a decompression indication may be generated by the system in which the memory system 110 is implemented, or may be generated by a portion of the memory system 110 itself (e.g., as a PSA detection or flag, based on an initial power-on condition detected at the memory system 110, based on an initial key-on indication from a vehicle, based on an indication from a vehicle manufacturing operation).

At 220, the memory system controller 115 may decompress the compressed data (e.g., in response to an indication to decompress the compressed data, at 215). In some cases, the memory system controller 115 may read the compressed data from the first storage location (e.g., the array of SLCs storing the compressed firmware image) to support decompressing the compressed data. The memory system controller 115 may decompress the compressed data using a decompression component 185, which, in some examples, may obtain decompressed data in accordance with one or more symbols and a bitmap associated with (e.g., included in) the compressed data. For example, the decompression component 185 may obtain a sequence of decompressed bits (e.g., having a quantity of bits that is greater than the quantity of bits associated with the compressed data) based on mapping each of the one or more symbols in accordance with the one or more respective locations indicated by the bitmap. In some examples, the decompressed data may be associated with a firmware image for the memory system 110.

At 225, the memory system 110 (e.g., the memory system controller 115, one or more local controllers 135, or a combination thereof) may store the decompressed data to a second storage location of the memory system 110. In some cases, the memory system controller 115 may store the decompressed data in accordance with a second write configuration, which may be associated with writing the data to memory cells having a second storage density that is greater than the first storage density (e.g., multiple-level cells each configured to store multiple bits of data, such as MLCs, TLCs, or QLCs). For example, the memory system controller 115 may store, in accordance with the second write configuration, the decompressed data to a set of TLCs (e.g., corresponding to the second storage location), such as one or more TLC arrays included in one or more memory devices 130 of the memory system 110. In some examples, the first storage location (e.g., SLCs, for storing the compressed data) and the second storage location (e.g., TLCs, for storing the decompressed data) may be different storage locations, and may be associated with (e.g., located within) the same or different memory devices 130 of the memory system 110. For example, the first storage location may be associated with one or more first memory devices 130 of the memory system 110 and the second storage location may be associated with one or more second memory devices 130 of the memory system 110, or the first storage location and the second storage location may be associated with the same memory device 130 of the memory system 110.

In some examples, the memory system controller 115 may store the decompressed data at least partially concurrently with decompressing the data (e.g., at 220). For example, the memory system controller 115 may determine a symbol of the one or more symbols and the respective locations of the symbol according to the compressed data, and may program the symbol to the respective locations within the second storage location. Such techniques may improve storage speeds associated with the decompressed data, for example, due to the memory system controller 115 performing copy operations for programming repetitions of the symbol (e.g., in comparison to performing a separate programming operation for each symbol repetition). Additionally, storing the decompressed data to memory cells having a relatively higher storage density (e.g., the TLC array) may improve performance of the memory system 110 while in the operational mode, such as by reducing a quantity of memory cells used to store the firmware image, providing additional available storage space for user data, or leveraging relatively less complex or faster read operations (e.g., associated with reading compressed data, which may be performed a single time at 220, in accordance with the described techniques), among other benefits.

At 230, the memory system 110 may perform operations using the decompressed data. For example, the memory system 110 may operate according to the configured set of operations or instructions included in the firmware image file, which may support the memory system 110 storing data (e.g., user data), executing commands, or performing media management operations, among other operations associated with a deployment scenario for the memory system 110.

Thus, in accordance with these and other examples, a memory system 110 may be configured to store compressed data during a pre-programming operation and maintain the compressed data until receiving or generating a decompression trigger (e.g., from a host system 105, from a component of the memory system 110). For example, a memory system 110 may receive compressed data during a manufacturing operation and store the compressed data according to a first write configuration (e.g., storing to a set of SLCs of the memory system 110). Storing the compressed data according to the first write configuration may be associated with a relatively lower amount of data (e.g., a relatively lower quantity of bits), a reduced bandwidth, or both compared to decompressed data, and may improve programming times, manufacturing efficiency, and data retention (e.g., during a powered-off duration, during high-temperature operations or storage conditions). The memory system 110 may (e.g., at a later time) decompress the data and store the decompressed data according to a second write configuration (e.g., storing to a set of TLCs of the memory system 110), which may be performed in response to receiving an indication to decompress the compressed data (e.g., from a host system 105). The indication may be received based on the memory system 110 entering an operational mode (e.g., a first power-on of a device including the memory system 110), and storing the decompressed data according to the second write configuration may be associated with improved operational performance of the memory system 110, such as freeing up storage capacity by moving the data to higher-density storage, reducing a read complexity or latency, or both (e.g., by performing a one-time decompression at a later time). Thus, the described techniques may improve manufacturing efficiency and operational performance of a memory system 110, compared to other techniques that do not implement such compression and decompression techniques.

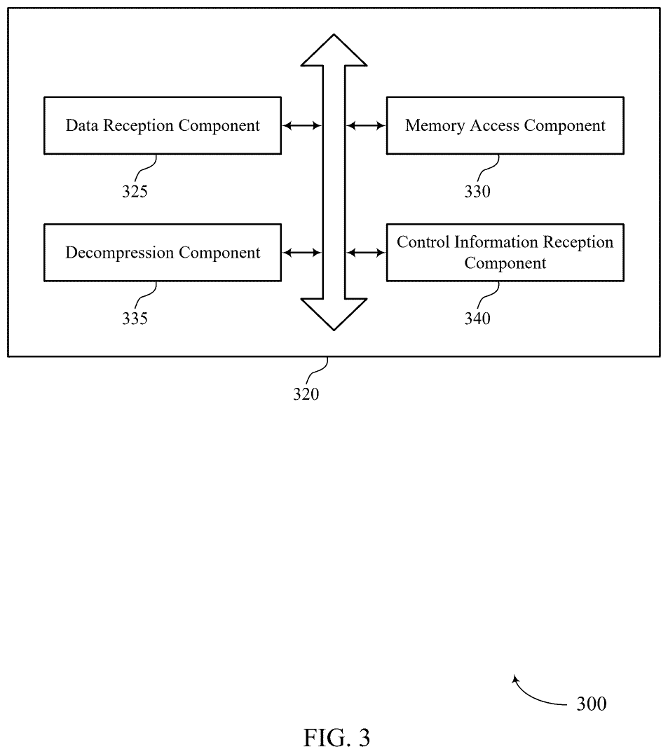

FIG. 3 shows a block diagram 300 of a memory system 320 that supports data storage and decompression in a memory system in accordance with examples as disclosed herein. The memory system 320 may be an example of aspects of a memory system as described with reference to FIGS. 1 through 2. The memory system 320, or various components thereof, may be an example of means for performing various aspects of data storage and decompression in a memory system as described herein. For example, the memory system 320 may include a data reception component 325, a memory access component 330, a decompression component 335, a control information reception component 340, or any combination thereof. Each of these components, or components of subcomponents thereof (e.g., one or more processors, one or more memories), may communicate, directly or indirectly, with one another (e.g., via one or more buses).

The data reception component 325 may be configured as or otherwise support a means for receiving compressed data to be stored at the memory system 320. The memory access component 330 may be configured as or otherwise support a means for storing the compressed data to a first storage location of one or more memory devices of the memory system 320 in accordance with a first write configuration. The memory access component 330 may be configured as or otherwise support a means for reading the compressed data from the first storage location. The decompression component 335 may be configured as or otherwise support a means for decompressing the compressed data to obtain decompressed data based on reading the compressed data from the first storage location. In some examples, the memory access component 330 may be configured as or otherwise support a means for writing the decompressed data to a second storage location of the one or more memory devices in accordance with a second write configuration that is different from the first write configuration.

In some examples, receiving the compressed data includes receiving an indication of one or more symbols each including a respective pattern of plurality of bits, and receiving a bitmap defining one or more respective locations for each of the one or more symbols; and decompressing the compressed data includes obtaining a sequence of decompressed bits based on mapping each of the one or more symbols in accordance with the one or more respective locations.

In some examples, the control information reception component 340 may be configured as or otherwise support a means for receiving an indication to decompress the compressed data, where reading the compressed data from the first storage location and decompressing the compressed data are based at least in part on receiving the indication.

In some examples, the compressed data is received from a first host system and prior to the memory system 320 being coupled with a second host system; and the indication to decompress the compressed data is received from the second host system and after coupling the memory system 320 with the second host system.

In some examples, receiving the compressed data is associated with a relatively lower amount of data, a reduced bandwidth, or both compared to receiving the decompressed data.

In some examples, receiving the indication to decompress the compressed data is responsive to the memory system 320 entering an operational mode.

In some examples, the first write configuration is associated with writing to memory cells in accordance with a first storage density and the second write configuration is associated with writing to memory cells in accordance with a second storage density that is greater than the first storage density.

In some examples, the first storage location includes a first set of one or more memory cells that are each configured to store a single bit of data and the second storage location includes a second set of one or more memory cells that are each configured to store a plurality of bits of data.

In some examples, the second storage location is different from the first storage location.

In some examples, the first storage location is associated with one or more first memory devices of the one or more memory devices; and the second storage location is associated with one or more second memory devices of the one or more memory devices different from the one or more first memory devices.

In some examples, the first storage location and the second storage location are associated with a same memory device of the one or more memory devices.

In some examples, the compressed data and the decompressed data are associated with a firmware image for the memory system 320.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

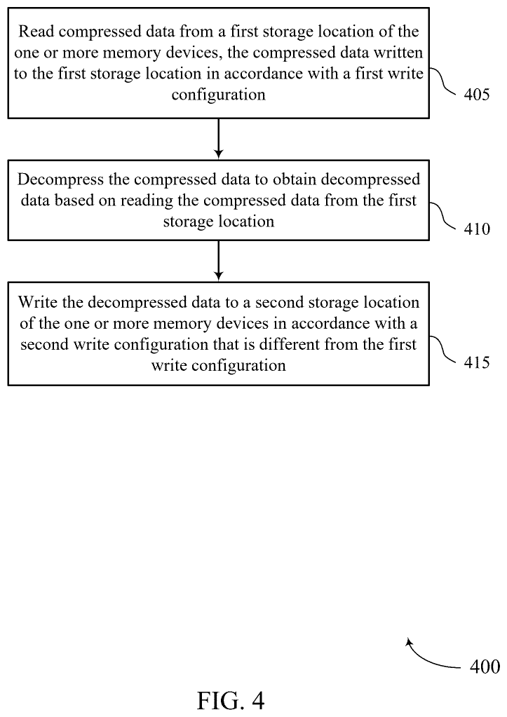

FIG. 4 shows a flowchart illustrating a method 400 that supports data storage and decompression in a memory system in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include reading compressed data from a first storage location of the one or more memory devices, the compressed data written to the first storage location in accordance with a first write configuration. In some examples, aspects of the operations of 405 may be performed by a memory access component 330 as described with reference to FIG. 3.

At 410, the method may include decompressing the compressed data to obtain decompressed data based on reading the compressed data from the first storage location. In some examples, aspects of the operations of 410 may be performed by a decompression component 335 as described with reference to FIG. 3.

At 415, the method may include writing the decompressed data to a second storage location of the one or more memory devices in accordance with a second write configuration that is different from the first write configuration. In some examples, aspects of the operations of 415 may be performed by a memory access component 330 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for reading compressed data from a first storage location of the one or more memory devices, the compressed data written to the first storage location in accordance with a first write configuration; decompressing the compressed data to obtain decompressed data based on reading the compressed data from the first storage location; and writing the decompressed data to a second storage location of the one or more memory devices in accordance with a second write configuration that is different from the first write configuration.
Aspect 2: The method, apparatus, or non-transitory computer-readable medium of aspect 1 further including operations, features, circuitry, logic, means, or instructions, or any combination thereof for receiving an indication to decompress the compressed data, where reading the compressed data from the first storage location and decompressing the compressed data are based at least in part on receiving the indication.
Aspect 3: The method, apparatus, or non-transitory computer-readable medium of aspect 2, where receiving the indication to decompress the compressed data is responsive to the memory system entering an operational mode.
Aspect 4: The method, apparatus, or non-transitory computer-readable medium of any of aspects 2 through 3, where the compressed data is received from a first host system and prior to the memory system being coupled with a second host system; and the indication to decompress the compressed data is received from the second host system and after coupling the memory system with the second host system.
Aspect 5: The method, apparatus, or non-transitory computer-readable medium of any of aspects 1 through 4, further including operations, features, circuitry, logic, means, or instructions, or any combination thereof for receiving compressed data to be stored at the memory system, and storing the compressed data to a first storage location of one or more memory devices of the memory system in accordance with a first write configuration.
Aspect 6: The method, apparatus, or non-transitory computer-readable medium of aspect 5, where receiving the compressed data includes receiving an indication of one or more symbols each including a respective pattern of plurality of bits, and receiving a bitmap defining one or more respective locations for each of the one or more symbols; and decompressing the compressed data includes obtaining a sequence of decompressed bits based on mapping each of the one or more symbols in accordance with the one or more respective locations.
Aspect 7: The method, apparatus, or non-transitory computer-readable medium of any of aspects 5 through 6, where receiving the compressed data is associated with a relatively lower amount of data, a reduced bandwidth, or both compared to receiving the decompressed data.
Aspect 8: The method, apparatus, or non-transitory computer-readable medium of any of aspects 1 through 7, where the first write configuration is associated with writing to memory cells in accordance with a first storage density and the second write configuration is associated with writing to memory cells in accordance with a second storage density that is greater than the first storage density.
Aspect 9: The method, apparatus, or non-transitory computer-readable medium of any of aspects 1 through 8, where the first storage location includes a first set of one or more memory cells that are each configured to store a single bit of data and the second storage location includes a second set of one or more memory cells that are each configured to store a plurality of bits of data.
Aspect 10: The method, apparatus, or non-transitory computer-readable medium of any of aspects 1 through 9, where the second storage location is different from the first storage location.
Aspect 11: The method, apparatus, or non-transitory computer-readable medium of any of aspects 1 through 10, where the first storage location is associated with one or more first memory devices of the one or more memory devices; and the second storage location is associated with one or more second memory devices of the one or more memory devices different from the one or more first memory devices.
Aspect 12: The method, apparatus, or non-transitory computer-readable medium of any of aspects 1 through 11, where the first storage location and the second storage location are associated with a same memory device of the one or more memory devices.
Aspect 13: The method, apparatus, or non-transitory computer-readable medium of any of aspects 1 through 12, where the compressed data and the decompressed data are associated with a firmware image for the memory system.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
read compressed data from a first storage location of the one or more memory devices, the compressed data written to the first storage location in accordance with a first write configuration;
decompress the compressed data to obtain decompressed data based on reading the compressed data from the first storage location; and
write the decompressed data to a second storage location of the one or more memory devices in accordance with a second write configuration that is different from the first write configuration.

2. The memory system of claim 1, wherein the processing circuitry is further configured to cause the memory system to:
receive an indication to decompress the compressed data, wherein reading the compressed data from the first storage location and decompressing the compressed data are based on receiving the indication.

3. The memory system of claim 2, wherein the processing circuitry is configured to cause the memory system to:
receive the indication to decompress the compressed data in response to the memory system entering an operational mode.

4. The memory system of claim 2, wherein:
the compressed data is received from a first host system and prior to the memory system being coupled with a second host system; and
the indication to decompress the compressed data is received from the second host system and after coupling the memory system with the second host system.

5. The memory system of claim 1, wherein the processing circuitry is further configured to cause the memory system to:
receive the compressed data to be stored at the memory system; and
store the compressed data to the first storage location of the one or more memory devices in accordance with the first write configuration.

6. The memory system of claim 5, wherein:
to receive the compressed data, the processing circuitry is configured to cause the memory system to receive an indication of one or more symbols each including a respective pattern of plurality of bits, and receive a bitmap defining one or more respective locations for each of the one or more symbols; and
to decompress the compressed data, the processing circuitry is configured to cause the memory system to obtain a sequence of decompressed bits based on mapping each of the one or more symbols in accordance with the one or more respective locations.

7. The memory system of claim 5, wherein the configuration to receive the compressed data is associated with a relatively lower amount of data, a reduced bandwidth, or both compared to receiving the decompressed data.

8. The memory system of claim 1, wherein the first write configuration is associated with writing to memory cells in accordance with a first storage density and the second write configuration is associated with writing to memory cells in accordance with a second storage density that is greater than the first storage density.

9. The memory system of claim 1, wherein the first storage location comprises a first set of one or more memory cells that are each configured to store a single bit of data and the second storage location comprises a second set of one or more memory cells that are each configured to store a plurality of bits of data.

10. The memory system of claim 1, wherein the second storage location is different from the first storage location.

11. The memory system of claim 1, wherein:
the first storage location is associated with one or more first memory devices of the one or more memory devices; and
the second storage location is associated with one or more second memory devices of the one or more memory devices different from the one or more first memory devices.

12. The memory system of claim 1, wherein the first storage location and the second storage location are associated with a same memory device of the one or more memory devices.

13. The memory system of claim 1, wherein the compressed data and the decompressed data are associated with a firmware image for the memory system.

14. A method by a memory system, comprising:
reading compressed data from a first storage location of one or more memory devices of the memory system, the compressed data written to the first storage location in accordance with a first write configuration;
decompressing the compressed data to obtain decompressed data based on reading the compressed data from the first storage location; and
writing the decompressed data to a second storage location of the one or more memory devices in accordance with a second write configuration that is different from the first write configuration.

15. The method of claim 14, further comprising:
receiving an indication to decompress the compressed data, wherein reading the compressed data from the first storage location and decompressing the compressed data are based at least in part on receiving the indication.

16. The method of claim 15, wherein receiving the indication to decompress the compressed data is responsive to the memory system entering an operational mode.

17. The method of claim 15, wherein:
the compressed data is received from a first host system and prior to the memory system being coupled with a second host system; and
the indication to decompress the compressed data is received from the second host system and after coupling the memory system with the second host system.

18. The method of claim 14, further comprising:
receiving the compressed data to be stored at the memory system; and
storing the compressed data to the first storage location of the one or more memory devices in accordance with the first write configuration.

19. The method of claim 18, wherein:
receiving the compressed data comprises receiving an indication of one or more symbols each including a respective pattern of plurality of bits, and receiving a bitmap defining one or more respective locations for each of the one or more symbols; and
decompressing the compressed data comprises obtaining a sequence of decompressed bits based on mapping each of the one or more symbols in accordance with the one or more respective locations.

20. The method of claim 14, wherein the first write configuration is associated with writing to memory cells in accordance with a first storage density and the second write configuration is associated with writing to memory cells in accordance with a second storage density that is greater than the first storage density.

21. The method of claim 14, wherein the first storage location comprises a first set of one or more memory cells that are each configured to store a single bit of data and the second storage location comprises a second set of one or more memory cells that are each configured to store a plurality of bits of data.

22. A non-transitory computer-readable medium storing code comprising instructions which, when executed by processing circuitry of a memory system, cause the memory system to:
read compressed data from a first storage location of one or more memory devices of the memory system, the compressed data written to the first storage location in accordance with a first write configuration;
decompress the compressed data to obtain decompressed data based on reading the compressed data from the first storage location; and
write the decompressed data to a second storage location of the one or more memory devices in accordance with a second write configuration that is different from the first write configuration.
